(19) United States
(12) Patent Application Publication
(10) Pub. No.: US 2012/0230502 A1
(43) Pub. Date: Sep. 13, 2012

(54) HEARING AID FITTING DEVICE

(76) Inventors: Makoto NISHIZAKI, Tokyo (JP); Hiroshi Kondo, Ehime (JP)

(21) Appl. No.: 13/411,940

(22) Filed: Mar. 5, 2012

(30) Foreign Application Priority Data
Mar. 9, 2011 (JP) 2011-051156

(51) Int. Cl. H04R 29/00

(52) U.S. Cl. 381/60

(57) ABSTRACT

A hearing aid fitting device has a display section and a monitoring section. The display section is able to display information for fitting a hearing aid. The monitoring section displays operating mode information, which indicates whether or not an operating mode in which hearing aid processing in the standard mode and additional hearing aid processing are executed is operating actively in the hearing aid, and hearing aid processing sound that has undergone hearing aid processing, on the display section.

### BACKGROUND OF THE INVENTION

1. Field of the Invention

The present invention relates to a hearing aid fitting device for fitting a hearing aid according to the hearing ability of a user and other such conditions.

2. Description of the Related Art

A hearing aid can be adjusted to match the hearing ability of a user by means of a hearing aid fitting device.

For example, Patent Literature 1 discloses a display screen for a hearing aid fitting device used in the course of hearing aid fitting. Specifically, the uncomfortable loudness level (UCL) and the hearing threshold level (HTL) of the hearing aid user are displayed on a graph in which the horizontal coordinate is frequency (hertz (Hz)) and the vertical coordinate is the volume (dB) of the output sound from the hearing aid. The maximum sound level (peak indicator) outputted from the hearing aid at various frequency bands is displayed in this graph. If the peak indicator is between the UCL and the HTL, this means that the hearing aid user can hear the sound properly. Therefore, this graph is used to check hearing aid fitting.

### CITATION LIST

### Patent Literature

Patent Literature 1: Japanese Unexamined Patent Application Publication (Translation of PCT Application) No. 2009-531883

### SUMMARY OF THE INVENTION

Today's digital hearing aids come with a variety of added functions so that optimal hearing aid processing can be performed for each usage environment. These added functions are automatically activated or deactivated according to the characteristics of the sound captured by the microphone of the hearing aid, so as to match special environments, such as a noisy environment or an environment of speaking on the telephone.

It can be difficult for a hearing aid fitter to tell whether this operation according to the environment (operating mode) is working actively or not. For example, even though the operating mode of a hearing aid being fitted may not be operating actively, there is the risk that the fitter will end up mistakenly perceiving the operating mode as operating actively during the fitting.

In a situation such as this, for example, when hearing aid fitting is performed using the hearing aid fitting device discussed in Patent Literature 1, the hearing aid fitter cannot properly check how well the hearing aid has been fitted. As a result, there is the risk of improper fitting of the hearing aid. In the following discussion, a state in which the operating mode is actively operating will also be called an “active state”.

It is an object of the present invention to reduce improper hearing aid fitting by allowing the operating mode to be correctly identified during the fitting of a hearing aid having an additional function that enters its active state according to the situation.

The hearing aid fitting device disclosed herein is for fitting a hearing aid having a plurality of different hearing aid processing modes, including a standard mode, said hearing aid fitting device having a display section and a display controller. The display section can display information for fitting the hearing aid. The display controller displays operating mode information, which indicates whether or not an operating mode in which hearing aid processing in the standard mode and additional hearing aid processing are executed is operating actively in the hearing aid, and sound volume that has undergone hearing aid processing, on the display section.

With this hearing aid fitting device, the display controller displays operating mode information and sound volume on the display section. Consequently, the hearing aid fitter can recognize whether or not the operating mode is actually operating in the hearing aid. That is, the hearing aid fitter can recognize that hearing aid processing in the standard mode and additional hearing aid processing are being executed in the hearing aid. Therefore, the hearing aid fitter can check the sound volume while correctly recognizing the state of the hearing aid.

### Effects of the Invention

Since the hearing aid fitter thus performs fitting of the hearing aid while correctly recognizing the operating mode of the hearing aid during hearing aid fitting, it is less likely that improper fitting will Occur.

### BRIEF DESCRIPTION OF DRAWINGS

FIG. 1 is a diagram of the configuration of a hearing aid fitting device pertaining to an embodiment of the present invention;

FIG. 2 is a control block diagram of the hearing aid fitting device in FIG. 1;

FIG. 3 is a diagram of an example of the fitting screen of the hearing aid fitting device in FIG. 1;

FIG. 4 is a diagram of an example of the monitoring screen of the hearing aid fitting device in FIG. 1;

FIG. 5 is a diagram of an example of the monitoring screen of the hearing aid fitting device in

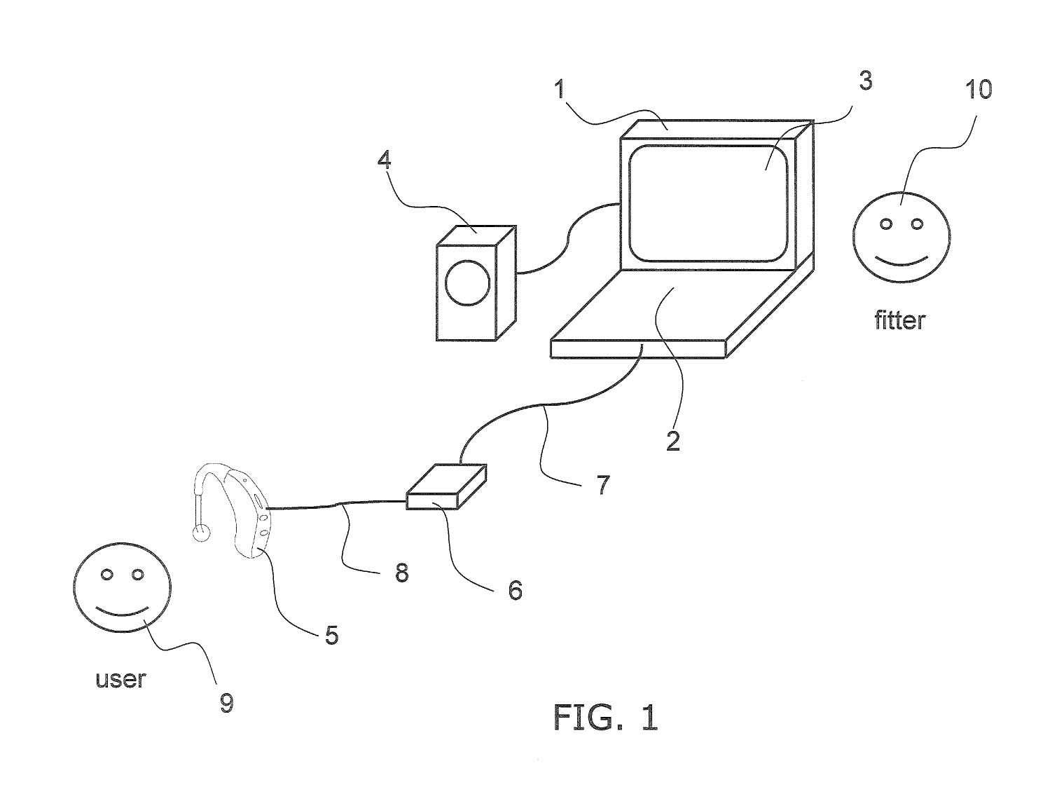

FIG. 1;

FIG. 6 is a diagram of an example of the monitoring screen of the hearing aid fitting device in FIG. 1; and

FIG. 7 is a control block diagram of the hearing aid fitting device in FIG. 1.

### DETAILED DESCRIPTION OF THE INVENTION

### First Embodiment

The device pertaining to an embodiment of the present invention will now be described through reference to FIGS. 1 to 6.

<Constitution>

The constitution of the hearing aid fitting device 1 pertaining to this embodiment will now be described through reference to the drawings.

As shown in FIG. 1, the hearing aid fitting device 1 in this embodiment comprises an input section 2 and a display section 3 disposed on the front part, and a sound output section 4. This hearing aid fitting device 1 is connected to a hearing aid 5 via a connector box 6, a wire 7, and a wire 8. The hearing aid 5 is used on both the left and right ears of the user, but in FIG. 1 only the one for the right ear is shown. The hearing aid for the left ear can be fitted in the same manner as described below.

A fitter 10 sets up the hearing aid 5 by changing the hearing aid processing parameters via the input section 2. At this point, the sound output section 4 outputs an evaluation sound source for evaluating the fitting.

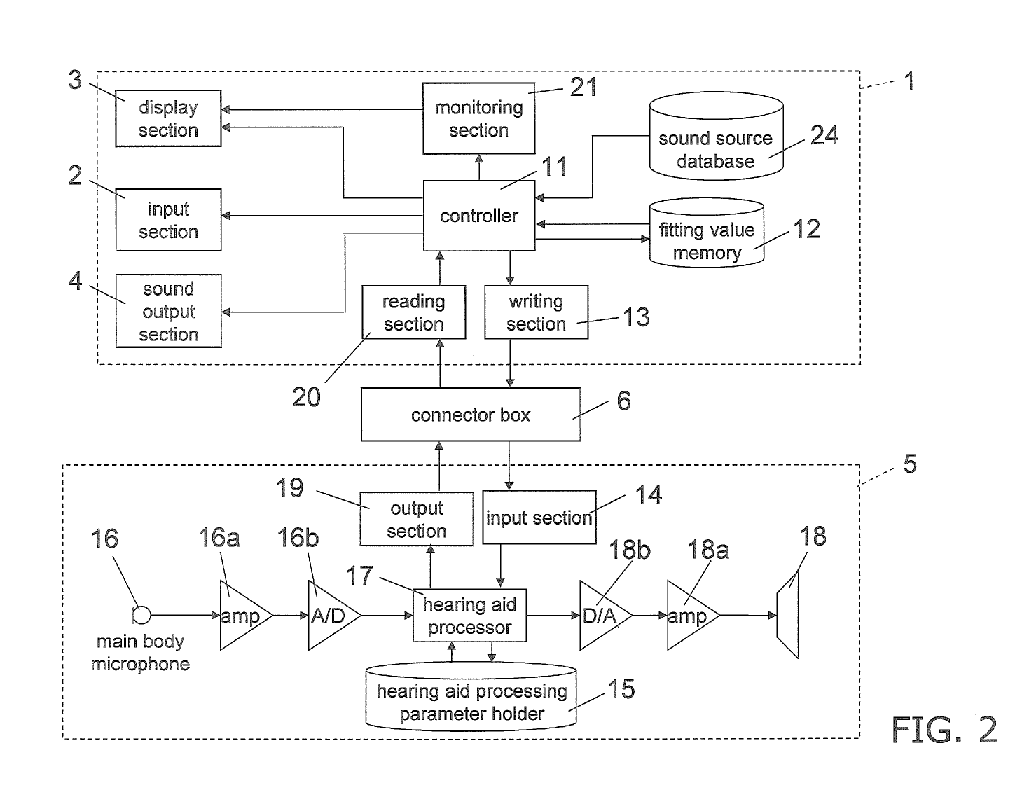

FIG. 2 is a control block diagram of the hearing aid fitting device 1.

A controller 11 is a processor, for example, which handles most of the processing in the hearing aid fitting device 1. The controller 11 controls the functions of the various function blocks of the hearing aid fitting device 1.

When the fitter 10 inputs or changes a fitting value via the input section 2, the inputted or changed fitting value is stored in a fitting value memory 12 via the controller 11, and is displayed on the display section 3 via the controller 11. When the fitter 10 uses the input section 2 to input a command to write the fitting value to the hearing aid 5, a writing section 13 writes the fitting value to a hearing aid processing parameter holder 15 of the hearing aid 5 via the connector box 6 and an input section 14 of the hearing aid 5. The controller 11 controls the writing section 13 on the basis of the write command inputted to the input section 2. The hearing aid processing parameter holder 15 stores hearing aid processing parameters such as gain and compression determined according to the hearing ability of a user 9, and setting information for additional functions such as a feedback canceller function, a wind suppression function, or a moderation function.

The hearing aid 5 uses a hearing aid processor 17 to process sound acquired by a main body microphone 16 (an example of a microphone) on the basis of the hearing aid processing parameters stored in the hearing aid processing parameter holder 15, etc, and the result is outputted from a receiver 18, thereby providing sound that matches the hearing ability of the user 9. That is, the hearing aid processor 17 executes hearing aid processing.

The hearing aid 5 has an amplifier 16a, an A/D (analog/digital) converter 16b, an amplifier 18a, and a D/A (digital/analog) converter 18b.

The amplifier 16a amplifies the analog speech signal outputted from the main body microphone 16. The A/D converter 16b converts the analog speech signal outputted from the amplifier 16a into a digital speech signal.

The D/A converter 18b converts the digital speech signal outputted from the hearing aid processor 17 into an analog speech signal. The amplifier 18a amplifies the analog speech signal outputted from the D/A converter 18b.

Normally, the user 9 is asked to listen to sound outputted from the hearing aid 5 that has been fitted as discussed above, and further fine tuning is performed on the basis of this result. The operating state of the additional function of the hearing aid 5 at this point changes according to the characteristics of the sound captured by the main body microphone 16 of the hearing aid 5.

For example, feedback may occur depending on how the hearing aid 5 is worn. With the hearing aid 5, the operating mode can be activated so that the additional function that suppresses gain in the frequency band in which feedback occurs is put in an active state. However, in this state, that is, a state in which the additional function is actually activated, there is the risk that the fitter 10 cannot properly fit the hearing aid 5. More specifically, when the hearing aid 5 is operating in standard mode, the gain set in the active state of the additional function may be gain that is not suitable for the user 9.

To solve the above problem, with the hearing aid fitting device 1 pertaining to this embodiment, operating mode information 40 for the hearing aid 5 is displayed in an operating mode display region 410 (an example of a first display region) of the display section 3. Also, the volume of a hearing aid processing sound 39 that has undergone hearing aid processing in operating mode (an example of a hearing aid processing mode), and the volume of a hearing aid processing sound 38 that has undergone hearing aid processing in standard mode (an example of a hearing aid processing mode) are displayed in a sound volume display region 420 (an example of a second display region), matching the desired sound volume range for the user 9, so that the two can be distinguished from one another.

More specifically, the fitter 10 uses the input section 2 to select an evaluation sound source (an example of a sound source) provided to the user 9. The selected evaluation sound source is read from a sound source database 24 by the controller 11, and outputted via the sound output section 4. The “evaluation sound source” here is electronic data, for example, in a state in which it is stored in the sound source database 24, and is speech in a state in which it is outputted from the sound output section 4. The evaluation sound source thus presented is inputted through the main body microphone 16 to the hearing aid processor 17, then undergoes hearing aid processing by the hearing aid processor 17, and is provided to the user 9 via the receiver 18.

At this point, hearing aid processing is performed in the active state of the additional function, that is, a state in which the operating mode is operating actively, according to the characteristics of the sound captured by the main body microphone 16, and the hearing aid processing sound 39 in operating mode is provided to the user 9. In this embodiment, in addition to this operation, hearing aid processing is executed by the hearing aid processor 17 in a different mode from the operating mode. That is, as discussed above, hearing aid processing when the additional function is in a deactivated state, namely, in the standard mode, is performed by the hearing aid processor 17 on the evaluation sound source captured by the main body microphone 16. Thus, the hearing aid processing sound 38 processed by the standard mode is produced substantially simultaneously with the hearing aid processing sound 39 processed by the operating mode.

The hearing aid processing sound 38 processed by the standard mode and the hearing aid processing sound 39 processed by the operating mode are transmitted, along with the operating mode information 40 expressing the operating state of the additional function, to the hearing aid fitting device 1 via an output section 19, the connector box 6, and a reading section 20 (an example of a communication section).

The phrase “the hearing aid processing sound 38 in standard mode is transmitted” here means that a signal representing the hearing aid processing sound 38 processed by the standard mode is transmitted. Similarly, the phrase “the hearing aid processing sound 39 processed by the operating mode” means that a signal representing the hearing aid processing sound 39 processed by the operating mode is transmitted. The phrase “the operating mode information 40 is transmitted” means that a mode signal representing the operating mode information 40 is transmitted.

With the hearing aid fitting device 1, information that is important in the fitting of the hearing aid 5 is displayed on the display section 3 on the basis of the result of hearing aid processing by operating mode, the result of hearing aid processing by standard mode, and the mode signal. Information for fitting the hearing aid 5 is thus presented to the fitter 10 through the display section 3.

<Operation>

The operation of the hearing aid fitting device 1 pertaining to this embodiment will now be described in detail.

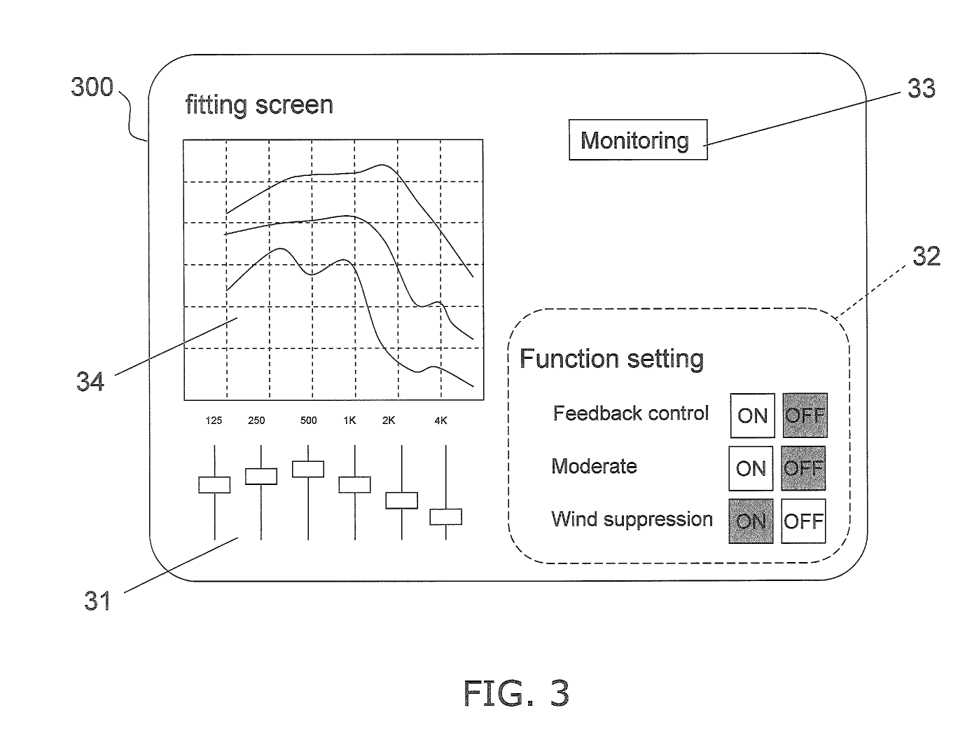

FIG. 3 is a diagram of an example of the fitting screen of the hearing aid fitting device pertaining to this embodiment.

In this embodiment, a fitting screen 300 is displayed on the display section 3 before starting monitoring. The fitter 10 moves a slider 31 up and down via the input section 2, and thereby sets the gain for each frequency band to match the hearing aid of the user 9.

Also, the fitter 10 presses the button of a function setting region 32 to set an additional function. That is, the fitter 10 designates the setting mode.

For example, FIG. 3 shows a state in which a wind suppression function has been set as an additional function. With the hearing aid 5, a mode in which hearing aid processing by wind suppression function is executed in addition to hearing aid processing in standard mode (an example of a setting mode, and an example of an operating mode).

In FIG. 3, the buttons are displayed as “on” or “off.” The fitter 10 can designate the wind suppression function by pressing the button displaying “on” that is disposed next to the wind suppression function. Also, the fitter 10 can switch off the wind suppression function by pressing the button displaying “off.” The fitter 10 is also able to designate a plurality of additional functions at the same time.

The “wind suppression function” here is a function of suppressing the effect of the sound section when a sound section that is specific to wind noise is detected from sound inputted to the main body microphone 16. More specifically, the wind suppression function is a function of automatically lowering the gain of a low frequency band in order to suppress the effect of a sound section that is specific to wind noise.

After gain or another such hearing aid processing parameter has thus been set as an additional function, the hearing aid 5 is subjected to other types of fitting. After this, the fitter 10 presses a monitoring button 33 to change the display of the display section 3 to a monitoring screen.

The three curves displayed in the gain display region 34 in FIG. 3 show the output characteristics at an SPL of 90, 60, and 40 dB, in that order starting from the top.

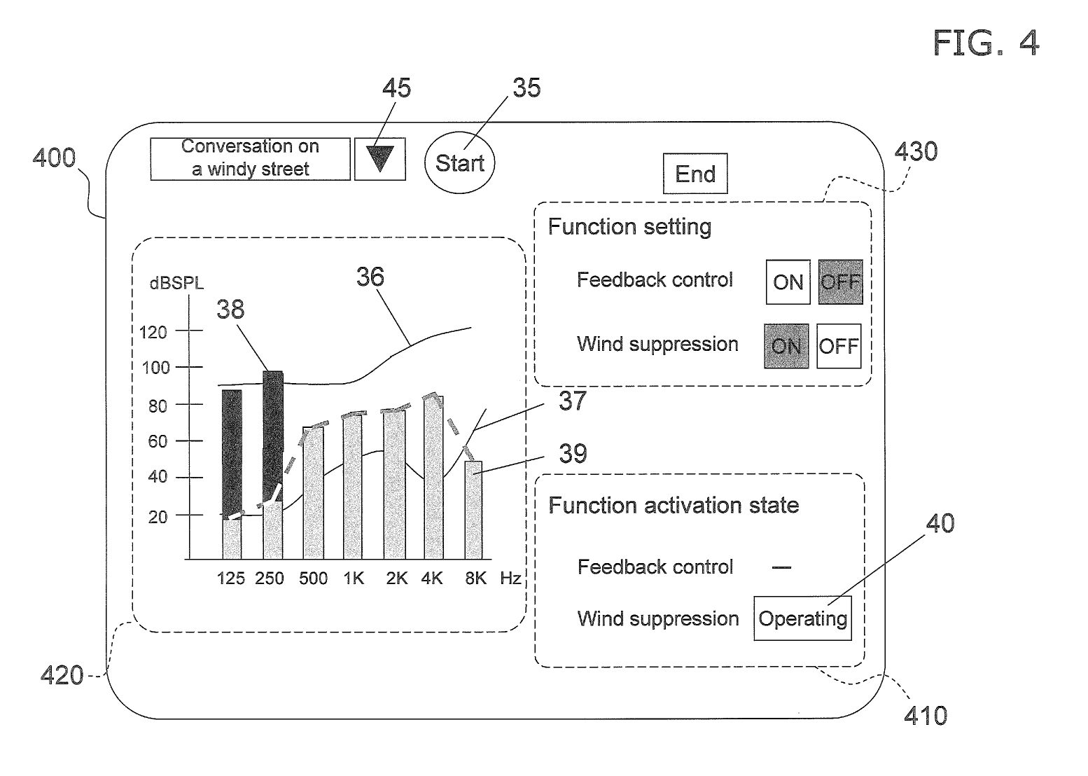

FIG. 4 shows a monitoring screen 400 displayed on the display section 3.

The fitter 10 uses a pull-down menu 45 to select the evaluation sound source to be used for evaluation from a list of evaluation sound sources. In this embodiment, conversation on a windy street is selected as the evaluation sound source. When the fitter 10 presses a start button 35, the selected evaluation sound source is outputted from the sound output section 4.

When the evaluation sound source is outputted from the sound output section 4, the evaluation sound source is inputted to the hearing aid 5 through the main body microphone 16 of the hearing aid 5.

The hearing aid processor 17 performs hearing aid processing on the basis of an additional function setting state and hearing aid processing parameters that match the hearing aid of the user 9. The hearing aid processor 17 analyzes the strength for each frequency by fast Fourier transform (FFT) or other such processing on the sound inputted to the main body microphone 16, after which the hearing aid processing parameters are used to perform different amplification processing for each frequency.

Along with this, the hearing aid processor 17 also performs fitting by additional function when it is determined that there is a need to actuate the additional function. That is, the hearing aid processor 17 performs hearing aid processing by operating mode.

The hearing aid processor 17 subjects a signal that has undergone fitting by additional function and amplification processing to processing that restores its waveform, by inverse discrete Fourier transform (IDFT). The strength of the sound at each frequency detected during fitting (that is, the spectral information) is monitored on the screen of the display section 3. The sound volume here can be expressed using spectral information. The hearing aid processor 17 decides whether or not to actively operate the additional function on the basis of the characteristics of the spectral information, for example.

In monitoring, the uncomfortable loudness level (UCL) 36 and the hearing threshold level (HTL) 37 of the user 9 are displayed on the screen. The sound volume of the hearing aid processing sound 38 (an example of a first processing sound) obtained by amplification processing using hearing aid processing parameters, the sound volume of the hearing aid processing sound 39 (an example of a second processing sound) obtained by executing hearing aid processing by additional function on the hearing aid processing sound 38, and the operating mode information 40 expressing the active state of the additional function are displayed on the display section 3.

The UCL 36 and the HTL 37 form a sound volume range (an example of a specific sound volume range). This sound volume range is set to match the hearing aid of the user 9, and is an example of the desired sound volume range of the user 9.

A monitoring section 21 (an example of a display controller) displays the monitoring screen 400 on the display section 3. The monitoring screen 400 includes the operating mode display region 410, the sound volume display region 420, and a setting mode display region 430.

The operating mode information 40 is displayed in the operating mode display region 410.

A graph of sound volume is displayed in the sound volume display region 420.

The volume of the hearing aid processing sound 38 and the volume of the hearing aid processing sound 39 are displayed in the sound volume display region 420. That is, a graph corresponding to the volume of the hearing aid processing sound 38 and a graph corresponding to the volume of the hearing aid processing sound 39 are each given a different color and displayed in the sound volume display region 420. Colors that are the same but have different gradation can be considered to be “different colors”.

The setting mode is displayed in the setting mode display region 430.

In FIGS. 4, 5, and 6, the operating mode display region 410, the sound volume display region 420, and the setting mode display region 430 (an example of a third display region) are indicated by broken lines. These broken lines are imaginary lines for the purpose of illustration.

The additional function of the hearing aid 5 does not always operate actively even though it has been set, but if a sound inputted through the main body microphone 16 meets a condition specific to this additional function, this function is activated (operates actively), and otherwise is deactivated (does not operate actively). The phrase “the additional function operates actively” here (that is, the operating mode operates actively) means that the additional function is in fact operating. If the additional function does not operate actively, the hearing aid 5 operates in standard mode.

More specifically, the “function setting” displayed in the setting mode display region 430 in the upper-left part of FIG. 4 shows whether or not the additional function of the hearing aid 5 has been set. If the set additional function is actually in its active state, “operating” is displayed as the operating mode information 40 in the operating mode display region 410.

If the hearing aid 5 is operating in standard mode, the “operating” is not displayed in the operating mode display region 410. In this case, “deactivated,” for example, is displayed in the operating mode display region 410. Thus, the operating mode information 40 shows which of the hearing aid processing modes is actively operating in the hearing aid 5. It is also conceivable that a plurality of additional functions will be operating actively at the same time.

The volume of the hearing aid processing sound 38 and the volume of the hearing aid processing sound 39 are displayed so that the user can tell them apart, using different colors, different textures, or other such graphical means. The hearing aid processing sound 38, the hearing aid processing sound 39, and the operating mode information 40 are outputted from the hearing aid 5, through the output section 19, the connector box 6, and the reading section 20, and to the hearing aid fitting device 1 by the hearing aid processor 17 in order to execute this display.

Information for performing monitoring and obtained as above is presented to the fitter 10 via the display section 3 of the hearing aid fitting device 1.

As shown in FIG. 4, the hearing aid processing sound 39 that has been processed by a wind suppression function (an additional function) is provided to the user 9. FIG. 4 shows that hearing aid processing sound 38 including wind noise in the low frequency region (125 Hz, 250 Hz) is provided to the user 9 when the wind suppression function is not working.

Accordingly, the fitter 10 can recognize that the hearing aid processing sound 38 obtained by hearing aid processing in standard mode is strongly affected by wind noise. Also, the fitter 10 can recognize that in standard mode, sound that exceeds the UCL 36 in the low frequency region is being provided to the user 9. The UCL 36 and the HTL 37 here are stored it the fitting value memory 12.

If the display method of this embodiment were not employed, the fitter 10 might think that fitting was inadequate for sound at 125 Hz and 250 Hz, and might further raise the sound volume in these frequency bands. That is, even though the hearing aid 5 is properly fitted when there is no wind noise, the fitting may be performed improperly since the operating state of the additional function is not known. Using the display method of this embodiment reduces such improper fitting.

Furthermore, the hearing aid fitting device 1 was described above using a wind suppression function as an example, but something other than a wind suppression function may be set as the additional function.

<Other Usage Example>

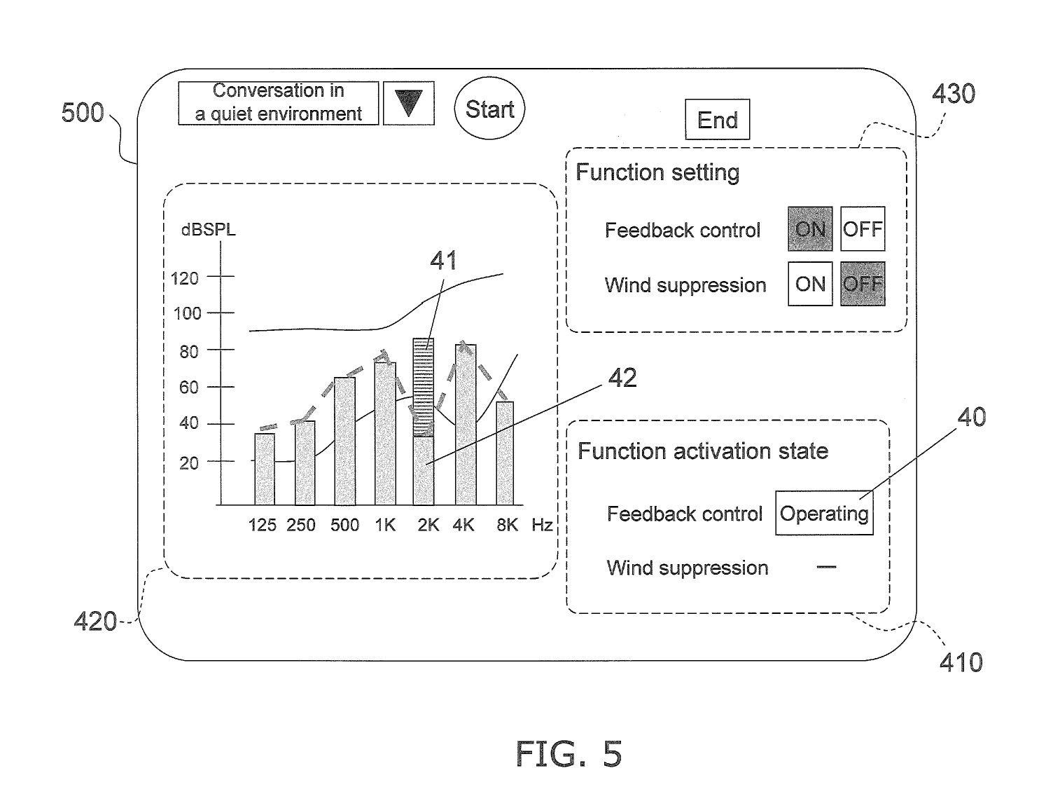

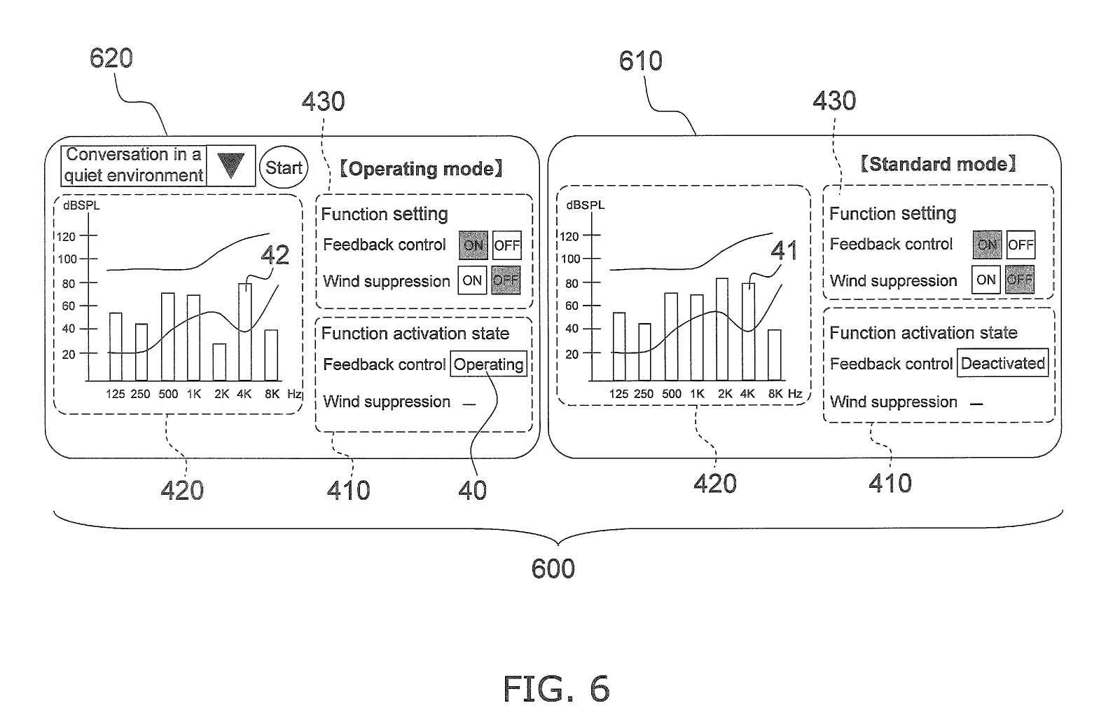

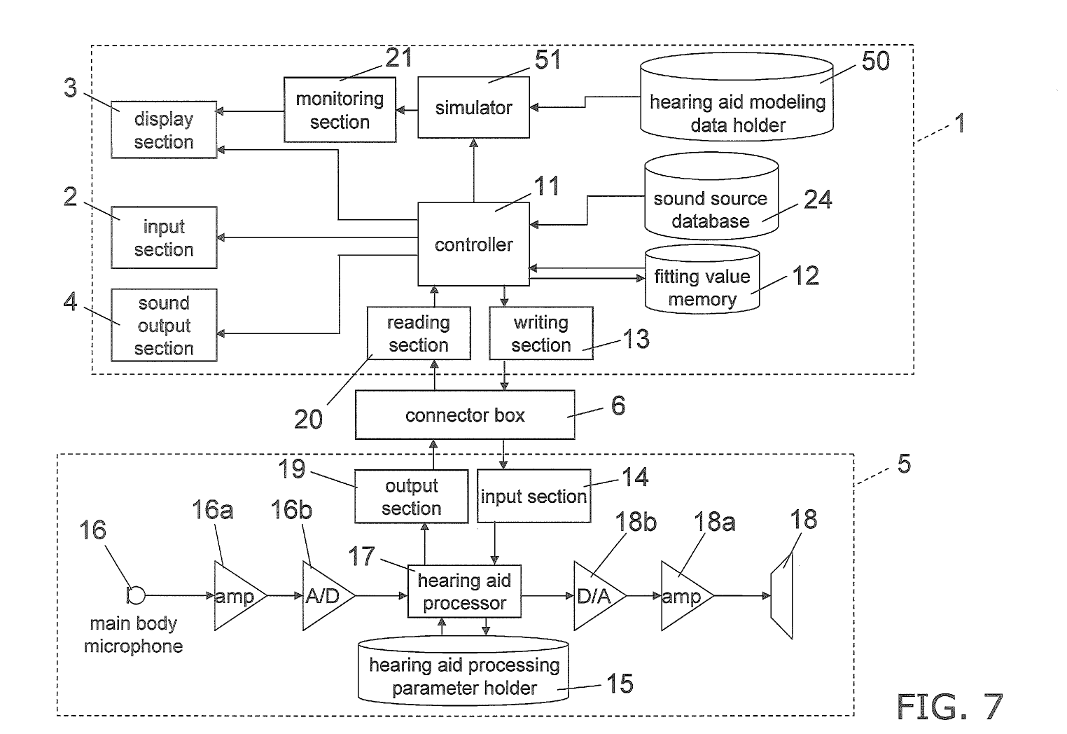

Another usage example of the hearing aid fitting device 1 pertaining to this embodiment will be described through reference to FIG. 5.

FIG. 5 shows a monitoring screen 500 in an example in which conversation sound in a quiet environment is used as the evaluation sound source.

The monitoring screen 500 includes the operating mode display region 410, the sound volume display region 420, and the setting mode display region 430.

We will assume here that the hearing aid 5 is evaluated using a different evaluation sound source just prior to having the user 9 listen to the evaluation sound source selected in FIG. 5. Further, in this prior evaluation, since the hearing aid 5 is not worn properly by the user 9, we will assume that sound leakage causes feedback to occur at a frequency band of 2 kHz.

To suppress this feedback, we will assume that a feedback suppression function has been set as an additional function. That is, a mode in which hearing aid processing is executed by a feedback suppression function (an example of a setting mode, and an example of an operating mode) has been set in the hearing aid 5 in addition to hearing aid processing in standard mode.

In a state such as this, even though feedback does not occur at the current point at which the evaluation sound source shown in FIG. 5 is used, feedback information may not be cancelled out by the hearing aid 5. Here, we will assume that feedback, which is not actually occurring, is mistakenly recognized by the hearing aid 5, and the feedback suppression function goes into its active state.

Thus, FIG. 5 shows a case in which the additional function should not be in an active state, and the hearing aid should be operating in standard mode, but the additional function is in fact in its active state for some reason.

In this case, the fitter 10 will not notice that the additional function is in its active state, and will perform hearing aid fitting while thinking that it is operating in standard mode. As a result, there is the risk that this may lead to improper fitting of the hearing aid.

FIG. 5 shows a state in which conversation sound in a quiet environment is provided to the user 9 as the evaluation sound source in the above situation.

In such a situation, the fitter 10 can recognize that the operating mode is actively operating by checking the monitoring screen 500. This tells the fitter 10 that the hearing aid 5 has mistakenly detected feedback. The fitter 10 then subjects the intended evaluation sound source to hearing aid processing in standard mode, and can recognize that a hearing aid processing sound 41 (an example of a first processing sound) is supposed to be provided to the user 9.

Furthermore, since the feedback suppression function is operating, the fitter 10 can recognize that a hearing aid processing sound 42 (an example of a second processing sound) is actually being supplied to the user 9. In other words, the fitter 10 can recognize that sound in the frequency band of 2 kHz is only being insufficiently provided to the user.

On the other hand, if the display method of this embodiment is not employed, just the hearing aid processing sound 42 will be displayed on the monitoring screen 500. In this case, if the hearing aid 5 ends up being fitted according to the monitoring screen 500, then when the user 9 actually uses the hearing aid 5, sound in the frequency band of 2 kHz will end up being amplified more than necessary. However, improper fitting such as this can be reduced by the display method of this embodiment.

<Action and Effect>

The action and effect of the hearing aid fitting device 1 pertaining to the first embodiment will now be described.

(1)

With this hearing aid fitting device 1, the monitoring section 21 displays the operating mode information 40, the volume of the hearing aid processing sound 38, and the volume of the hearing aid processing sound 39 on the display section 3. The operating mode information 40 shows whether or not the operating mode in which hearing aid processing based on a wind suppression function and hearing aid processing in standard mode is operating actively in the hearing aid 5.

Consequently, the fitter 10 can recognize whether or not the operating mode is actually operating in the hearing aid 5. That is, the fitter 10 can recognize that hearing aid processing based on the wind suppression function is being executed in addition to hearing aid processing in standard mode in the hearing aid 5. Therefore, the fitter 10 can confirm the sound volume while correctly recognizing the state of the hearing aid 5.

As a result, the occurrence of improper fitting of the hearing aid 5 can be curtailed.

(2)

With this hearing aid fitting device 1, the volume of the hearing aid processing sound 38 obtained by hearing aid processing in standard mode, and the volume of the hearing aid processing sound 39 obtained by hearing aid processing in operating mode are displayed on the display section 3.

Consequently, the fitter 10 can accurately ascertain the state of the hearing aid 5. Also, the effect that the usage environment has on the output sound volume of the hearing aid 5 can be ascertained. As a result, the hearing aid 5 can be fitted better.

(3)

The monitoring section 21 displays the operating mode display region 410 (in which the operating mode information 40 is displayed), the sound volume display region 420 (in which the volume of the hearing aid processing sound 38 and the volume of the hearing aid processing sound 39 are displayed), and the setting mode display region 430 (in which the setting mode is displayed) on the display section 3.

Consequently, the state of the hearing aid 5 is presented to the fitter 10 in a more organized format. As a result, the fitter 10 can more easily ascertain the state of the hearing aid 5.

(4)

The monitoring section 21 displays the hearing aid processing sound 38, the hearing aid processing sound 39, the UCL 36, and the HTL 37, contrasted with each other, on the display section 3.

Consequently, the fitter 10 can easily compare the volume of the sound obtained by hearing aid processing in a plurality of different modes. The fitter 10 can also confirm the standard used for fitting.

(5)

This hearing aid fitting device 1 has the reading section 20, which is disposed so as to be capable of communicating with the hearing aid 5 and to which the hearing aid processing sound 38, the hearing aid processing sound 39, and the operating mode information 40 are inputted from the hearing aid 5.

Consequently, the hearing aid processing sound 38 and the hearing aid processing sound 39 obtained by hearing aid processing in the hearing aid 5 are inputted to the hearing aid fitting device 1. Therefore, the fitter 10 can learn the state of the hearing aid 5 directly.

(6)

The monitoring section 21 displays a graph corresponding to the volume of the hearing aid processing sound 38 and a graph corresponding to the volume of the hearing aid processing sound 39 on the display section 3, with the graphs superposed and displayed in mutually different colors.

This allows the fitter 10 to easily ascertain the state of the hearing aid 5 visually.

### Second Embodiment

A second embodiment will be described through reference to FIG. 7.

FIG. 7 is a function block diagram of the hearing aid fitting device 1 pertaining to the second embodiment.

Those sections having substantially the same function as in the first embodiment will be numbered the same as in the first embodiment, and will not be described in detail again.

In the first embodiment above, the hearing aid processing sound 38 that had undergone amplification processing using hearing aid processing parameters corresponding to the standard mode, the hearing aid processing sound 39 that had further undergone hearing aid processing by additional function, and the operating mode information 40 expressing the active state of the additional function were outputted by the hearing aid 5 through the hearing aid processor 17. However, the hearing aid processing sound 38 and the hearing aid processing sound 39 do not necessarily have to be inputted from the hearing aid 5 to the hearing aid fitting device 1.

For example, it is possible that communication between the hearing aid 5 and the hearing aid fitting device 1 may be slow. In this case, just the sound information prior to hearing aid processing captured by the main body microphone 16, and the operating mode information 40 expressing the active state of the additional function may be sent from the hearing aid 5 to the hearing aid fitting device 1 via the hearing aid processor 17. This sound information and the operating mode information 40 are inputted through the reading section 20 to the hearing aid fitting device 1.

In this embodiment, the sound information outputted from the hearing aid 5 is based on the evaluation sound source outputted from the sound output section 4. The sound information outputted from the hearing aid 5 is produced by direct conversion into a speech signal, without the evaluation sound source captured by the main body microphone 16 undergoing hearing aid processing.

A simulator 51 of the hearing aid fitting device 1 simulates the processing of the hearing aid 5 on the basis of modeling data for the signal processing method of the hearing aid 5, etc., stored in a hearing aid modeling data holder 50 of the hearing aid fitting device 1, and the operating mode information 40 and the sound information inputted from the hearing aid 5. Also, the simulator 51 computes the hearing aid processing sound 38 by simulating the standard mode. The simulator 51 further computes the hearing aid processing sound 39 by simulating the operating mode. Here, the simulator 51 simulates a wind suppression function in the simulation of the operating mode.

The monitoring section 21 displays a monitoring screen corresponding to FIGS. 4, 5, and 6 on the display section 3, on the basis of the hearing aid processing sound 38 and the hearing aid processing sound 39 thus obtained.

In general, a processor that operates the hearing aid fitting device 1 (such as a PC (personal computer)) has better performance than the processor inside the hearing aid 5 in terms of computation speed. Also, the speed of communication performed through the connector box 6 may not be adequate for the purposes of processing in the first embodiment above.

Again in these cases, employing them in the hearing aid fitting device 1 pertaining to this embodiment achieves the goal of suppressing the occurrence of improper fitting of the hearing aid 5.

### Other Embodiments

First and second embodiments of the present invention were described above, but the present invention is not limited to the above embodiments, and various modifications are possible without departing from the gist of the invention.

(A) In the above embodiments, the hearing aid processing sound 38 and the hearing aid processing sound 39 (or the hearing aid processing sound 41 and the hearing aid processing sound 42) were outputted to a single graph displaying sound volume, but the present invention is not limited to this.

FIG. 6 shows a monitoring screen 600 pertaining to another embodiment. The monitoring screen 600 has a first screen 610 and a second screen 620. The first screen 610 and the second screen 620 include the operating mode display region 410, the sound volume display region 420, and the setting mode display region 430.

In the above embodiments, as shown in FIG. 5, the volume of the hearing aid processing sound 41 obtained by hearing aid processing in standard mode and the volume of the hearing aid processing sound 42 obtained by hearing aid processing in operating mode were displayed in mutually different formats. That is, the graph corresponding to the volume of the hearing aid processing sound 41 was hatched, and the graph corresponding to the volume of the hearing aid processing sound 42 was colored.

In contrast, as shown in FIG. 6, the display of the two modes can be presented on two screens using a mutually shared format. In FIG. 6, the operating mode and standard mode correspond to the second screen 620 on the left and the first screen 610 on the right. Consequently, the graph corresponding to the volume of the hearing aid processing sound 41 and the graph corresponding to the volume of the hearing aid processing sound 42 are displayed side by side. A display format such as this can also be used to display the hearing aid processing sound 41 and the hearing aid processing sound 42 so that they are contrasted.

Also, two screens were used in FIG. 6, but a first graph corresponding to the volume of the hearing aid processing sound 41 and a second graph corresponding to the volume of the hearing aid processing sound 42 may be displayed within a single screen. As long as the hearing aid processing sound 41 and the hearing aid processing sound 42 (or the hearing aid processing sound 38 and the hearing aid processing sound 39) can be displayed so that they can be distinguished from each other, any display format may be employed.

### (B)

In the above embodiments, the evaluation sound source inputted to the main body microphone 16 was converted into sound information, and the sound information was sent to the hearing aid fitting device 1, but the present invention is not limited to this.

For instance, this processing may be omitted. Specifically, the hearing aid fitting device 1 may simulate the evaluation sound source that the main body microphone 16 of the hearing aid 5 is supposed to detect. More precisely, the distance between the hearing aid 5 and the sound output section 4 (such as a speaker) is used as a parameter, for example. The fitter 10 then inputs the parameter through the input section 2 to the hearing aid fitting device 1, and the hearing aid fitting device 1 computes the sound that is supposed to be inputted to the main body microphone 16 according to this parameter.

In this case, processing for sending the hearing aid fitting device 1 sound information based on the sound inputted to the main body microphone 16 need not be performed.

(C)

In the above embodiments, The hearing aid 5 and the hearing aid fitting device 1 were connected via the connector box 6, the wire 7, and the wire 8, but the present invention is not limited to this.

For example, the hearing aid 5 and the hearing aid fitting device 1 may be connected by wireless communication.

(D)

In the above embodiments, the controller 11 and the monitoring section 21 were provided separately, but the present invention is not limited to this.

For example, the controller 11 may also serve the function of the monitoring section 21.

Also, the various processing in the above embodiments may be realized by hardware, or by software (including an OS (operating system), middleware, or along with a specific library). Furthermore, a mixture of software and hardware may be employed in the processing.

### INDUSTRIAL APPLICABILITY

The hearing aid fitting device of the present invention has the effect of suppressing the occurrence of improper fitting of a hearing aid by allowing a hearing aid fitter to correctly recognize the state of the hearing aid, and therefore can be widely applied to hearing aid fitting devices that are used to perform the fitting of various types of hearing aid.

1. A hearing aid fitting device for fitting a hearing aid having a plurality of different hearing aid processing modes, including a standard mode, said hearing aid fitting device comprising:
a display section configured to display information for fitting the hearing aid; and
a display controller configured to display operating mode information, which indicates whether or not an operating mode in which hearing aid processing in the standard mode and additional hearing aid processing are executed is operating actively in the hearing aid, and sound volume that has undergone hearing aid processing, on the display section.

2. The hearing aid fitting device according to claim 1,
wherein the display controller displays a first processing sound volume obtained by hearing aid processing in the standard mode, and second processing sound volume obtained by hearing aid processing in the operating mode, on the display section.

3. The hearing aid fitting device according to claim 2,
wherein the display controller displays a first display region for displaying the operating mode information, and a second display region for displaying the first processing sound volume and the second processing sound volume, on the display section.

4. The hearing aid fitting device according to claim 1,
wherein the display controller displays, out of the plurality of hearing aid processing modes, a third display region for displaying information about a setting mode set for the hearing aid, on the display section.

5. The hearing aid fitting device according to claim 2
wherein the display controller displays the first processing sound volume and the second processing sound volume, contrasted with each other, on the display section.

6. The hearing aid fitting device according to claim 2,
wherein the display controller displays the first processing sound volume, the second processing sound volume, and a specific volume range, contrasted with each other, on the display section.

7. The hearing aid fitting device according to claim 2,
further comprising a communication section that is disposed so as to be capable of communicating with the hearing aid and to which the first processing sound obtained by hearing aid processing in the standard mode based on a sound source, the second processing sound obtained by hearing aid processing in the operating mode based on the sound source, and the operating mode information are inputted from the hearing aid.

8. The hearing aid fitting device according to claim 2, further comprising:
a communication section that is disposed so as to be capable of communicating with the hearing aid and to which sound information based on a sound source acquired by a microphone of the hearing aid, and the operating mode information are inputted from the hearing aid; and
a simulator that computes the first processing sound volume obtained by hearing aid processing in the standard mode, and the second processing sound volume obtained by hearing aid processing in the operating mode, on the basis of the sound information and the operating mode information from the hearing aid.

9. The hearing aid fitting device according to claim 2,
wherein the display controller displays sound volume with respect to a frequency band as a graph on the display section, and superposes a graph corresponding to the first processing sound volume and a graph corresponding to the second processing sound volume, using mutually different colors in the display.
